(19) United States
(12) Patent Application Publication
(10) Pub. No.: US 2018/0270390 A1
(43) Pub. Date: Sep. 20, 2018

(54) INFORMATION PROCESSING APPARATUS AND SYSTEM AND NON-TRANSITORY COMPUTER READABLE MEDIUM

(71) Applicant: FUJI XEROX CO., LTD., Tokyo (JP)

(72) Inventors: Sakae OKAZAKI, Kanagawa (JP); Shunsuke KASAHARA, Kanagawa (JP); Yuichi SUGIYAMA, Kanagawa (JP); Masahiro SUZUKI, Kanagawa (JP); Masatoshi SUZUKI, Kanagawa (JP); Yasunori ASADA, Kanagawa (JP); Yoshiaki MORITA, Kanagawa (JP); Toshitsugu KIKUCHI, Kanagawa (JP)

(73) Assignee: FUJI XEROX CO., LTD., Tokyo (JP)

(21) Appl. No.: 15/690,905

(22) Filed: Aug. 30, 2017

(30) Foreign Application Priority Data
Mar. 16, 2017 (JP) 2017-051798

(51) Int. Cl. H04N 1/333; H04L 12/40; H04N 1/00

(52) U.S. Cl. CPC H04N 1/33384; H04L 12/40039; H04N 1/00907; H04N 1/00896; H04N 2201/0041; H04N 1/33346; H04N 2201/0049; H04N 2201/0031; H04N 2201/0094

(57) ABSTRACT

An information processing apparatus includes a switching unit and a controller. The information processing apparatus performs a data sending and receiving operation with an external apparatus via a data line which is compliant with a predetermined standard. The switching unit switches the information processing apparatus to a host device or a non-host device in accordance with a state of the information processing apparatus. The controller controls a data sending and receiving operation performed with the external apparatus. The controller controls a data sending and receiving operation for a host device when the information processing apparatus is switched to the host device. The controller controls a data sending and receiving operation for a non-host device when the information processing apparatus is switched to the non-host device.

### CROSS-REFERENCE TO RELATED APPLICATIONS

This application is based on and claims priority under 35 USC 119 from Japanese Patent Application No. 2017-051798 filed Mar. 16, 2017.

### BACKGROUND

### (i) Technical Field

The present invention relates to an information processing apparatus and system and a non-transitory computer readable medium.

### (ii) Related Art

As an interface standard used for connecting devices, the universal serial bus (USB) standard is known. As the USB standard, the USB On-The-Go (OTG) standard is defined. The OTG standard allows a peripheral (non-host device) operating as a USB device to have a host function to act as a host device. A dual-role device that can operate both as a host device and a non-host device is defined in the OTG standard.

The following technology for determining the states of devices is known. By using a USB cable having ID signal pins at both ends, one ID signal pin connected to one device is grounded, while the other ID signal pin connected to the other device is set in the open state, so that the states of the devices can be determined.

### SUMMARY

According to an aspect of the invention, there is provided an information processing apparatus including a switching unit and a controller. The information processing apparatus performs a data sending and receiving operation with an external apparatus via a data line which is compliant with a predetermined standard. The switching unit switches the information processing apparatus to a host device or a non-host device in accordance with a state of the information processing apparatus. The controller controls a data sending and receiving operation performed with the external apparatus. The controller controls a data sending and receiving operation for a host device when the information processing apparatus is switched to the host device. The controller controls a data sending and receiving operation for a non-host device when the information processing apparatus is switched to the non-host device.

### BRIEF DESCRIPTION OF THE DRAWINGS

Exemplary embodiments of the present invention will be described in detail based on the following figures, wherein:

FIG. 1 illustrates an example of an information processing system according to a first exemplary embodiment;

FIG. 2 illustrates an example of the information processing system according to the first exemplary embodiment;

FIG. 3 illustrates an example of the information processing system according to the first exemplary embodiment;

FIG. 4 illustrates a state transition table;

FIG. 5 is a flowchart illustrating an operation of the information processing system according to the first exemplary embodiment;

FIG. 6 illustrates an example of an information processing system according to a second exemplary embodiment;

FIG. 7 illustrates an example of the information processing system according to the second exemplary embodiment;

FIG. 8 illustrates an example of the information processing system according to the second exemplary embodiment; and

FIG. 9 is a flowchart illustrating an operation of the information processing system according to the second exemplary embodiment.

### DETAILED DESCRIPTION

### First Exemplary Embodiment

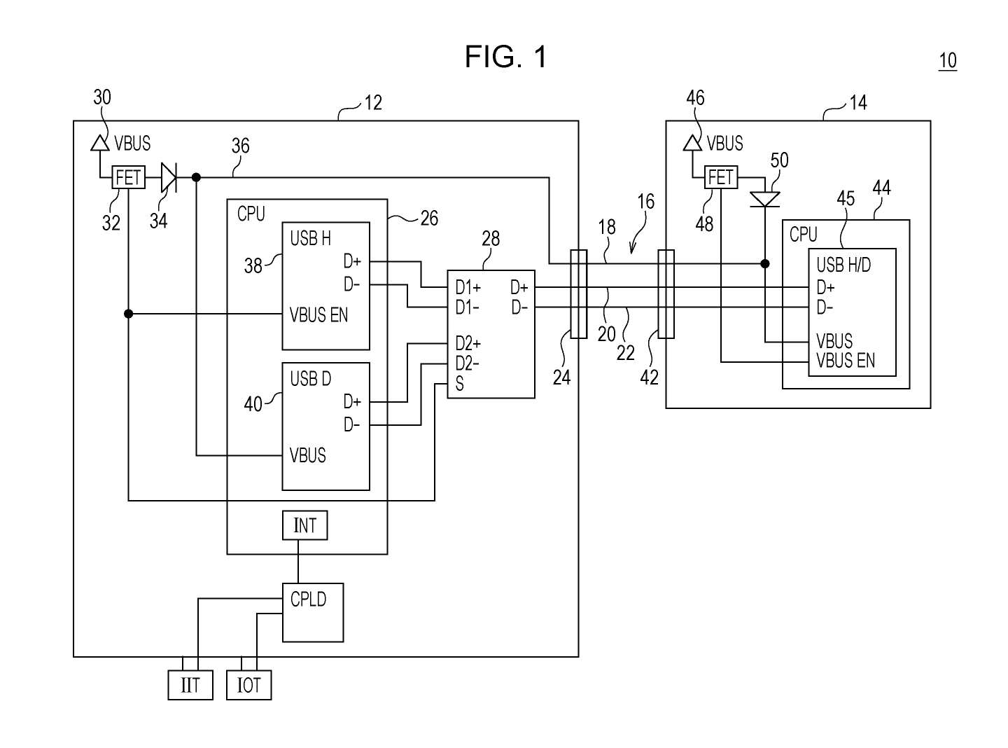

An information processing system 10 according to a first exemplary embodiment of the invention will be described below with reference to FIG. 1. FIG. 1 illustrates an example of the information processing system 10.

The information processing system 10 includes an image forming apparatus 12 which serves as a first device and a terminal apparatus 14 which serves as a second device. The image forming apparatus 12 and the terminal apparatus 14 are connected to each other via a universal serial bus (USB) cable 16 compliant with the USB standard. The image forming apparatus 12 and the terminal apparatus 14 send and receive data to and from each other via the USB cable 16. The image forming apparatus 12 corresponds to an example of an information processing apparatus, while the terminal apparatus 14 corresponds to an example of an external apparatus.

An overview of the image forming apparatus 12, the terminal apparatus 14, and the USB cable 16 will be described below.

The image forming apparatus 12 has an image forming function, and more specifically, at least one of a print function, a scan function, a copy function, and a fax function, for example. Upon receiving a control signal concerning image forming processing (for example, a job, such as a print job), the image forming apparatus 12 forms an image in accordance with the control signal. The control signal (job) may be sent to the image forming apparatus 12 from the terminal apparatus 14 via the USB cable 16 or from a device other than the terminal apparatus 14. The image forming apparatus 12 may have a function of performing wired communication according to a communication standard other than the USB standard or a function of performing wireless communication (such as Wi-Fi (registered trademark) communication and Bluetooth (registered trademark) communication). The image forming apparatus 12 may perform processing other than image forming processing. The image forming apparatus 12 may have a user interface. The user interface includes a display and an operation unit, for example. The display is a display device, such as a liquid crystal display, and the operation unit is an input device, such as an operation panel or a keyboard. The user interface may be a device which serves as both of a display and an operation unit (a touch panel display, for example).

The terminal apparatus 14 is a personal computer (PC) or a mobile terminal such as a smartphone, a tablet PC, or a cellular phone. The terminal apparatus 14 has a user interface. The user interface includes a display and an operation unit, for example. The display is a display device, such as a liquid crystal display, and the operation unit is an input device, such as an operation panel or a keyboard. The user interface may be a device which serves as both of a display and an operation unit (a touch panel display, for example). The terminal apparatus 14 may have a function of performing wired communication according to a communication standard other than the USB standard or a function of performing wireless communication (such as Wi-Fi communication and Bluetooth communication). When being connected to the image forming apparatus 12 via the USB cable 16, the terminal apparatus 14 may be used as a user interface of the image forming apparatus 12. In this case, a menu screen concerning a function of the image forming apparatus 12 (an image forming function, for example) is displayed on the user interface of the terminal apparatus 14, and a user provides an instruction to execute image forming processing by using this menu screen, for example. The terminal apparatus 14 may receive a job from another device and send this job to the image forming apparatus 12 via the USB cable 16 or another communication path.

The image forming apparatus 12 is only an example of the first device, and the terminal apparatus 14 is only an example of the second device. The first device may be another device (a PC, for example) other than the image forming apparatus 12, and the second device may be another device (a digital camera, for example) other than the terminal apparatus 14.

In the information processing system 10 according to the first exemplary embodiment, one of the image forming apparatus 12 and the terminal apparatus 14 functions as a host device (USB host) and the other one functions as a non-host device (USB device or peripheral). When the image forming apparatus 12 functions as a host device, the terminal apparatus 14 functions as a non-host device. When the image forming apparatus 12 functions as a non-host device, the terminal apparatus 14 functions as a host device.

The USB cable 16 includes a VBUS (power supply bus) line 18, which serves as a power supply line, and two data signal lines (D+ data signal line 20 and D− data signal line 22), which serve as data lines. Power is supplied to the VBUS line 18 from a host device and is then supplied to a non-host device via the VBUS line 18. Differential signaling is performed in the data signal lines 20 and 22.

The image forming apparatus 12 does not necessarily support the On-The-Go (OTG) standard if the terminal apparatus 14 supports it.

Details of the image forming apparatus 12 will be discussed below.

The image forming apparatus 12 includes a connector 24 which is compliant with the USB standard. One terminal of the USB cable 16 is connected to the connector 24. The image forming apparatus 12 is not a dual-role device.

Broadly speaking, the image forming apparatus 12 includes a controller 26, a selector 28, and a power supply unit 30. The controller 26 has a function of controlling the individual elements of the image forming apparatus 12. For example, the controller 26 has a function of controlling a data sending and receiving operation performed with the terminal apparatus 14 via the USB cable 16. The selector 28, which is an example of a switching unit, has a function of switching the state of the image forming apparatus 12 to a host device or a non-host device. The power supply unit 30, which is an example of a first power supply unit, is a power supply device that supplies power to the individual elements of the image forming apparatus 12. The power supply unit 30 is connected to the VBUS line 18 of the USB cable 16 via a field-effect transistor (FET) 32, a diode 34, a power supply line 36, and the connector 24 so as to supply power to the terminal apparatus 14 via these elements. Details of the individual elements of the image forming apparatus 12 will be discussed below.

When the image forming apparatus 12 acts as a host device (USB host), the controller 26 controls a data sending and receiving operation for a host device according to the USB standard. When the image forming apparatus 12 acts as a non-host device (USB device), the controller 26 controls a data sending and receiving operation for a non-host device according to the USB standard. More specifically, the controller 26 includes a host controller 38 that controls a data sending and receiving operation for a host device according to the USB standard and a non-host controller 40 that controls a data sending and receiving operation for a non-host device according to the USB standard. The host controller 38 functions as a USB host interface (IF), while the non-host controller 40 functions as a USB non-host IF.

The host controller 38 includes a terminal D+ and a terminal D−. The terminal D+ is connected to a terminal D1+ of the selector 28 via a data line, while the terminal D− is connected to a terminal D1− of the selector 28 via a data line.

The host controller 38 also includes a terminal VBUS EN from which a VBUS control signal is output. The terminal VBUS EN is connected to the FET 32 via a line. When the image forming apparatus 12 acts as a host device (USB host), the host controller 38 is driven by receiving power supplied from the power supply unit 30 so as to control a data sending and receiving operation performed with the terminal apparatus 14 and to cause the power supply unit 30 to supply power to the terminal apparatus 14. When the image forming apparatus 12 acts as a non-host device (USB device), the host controller 38 causes the power supply unit 30 to stop supplying power. Then, the image forming apparatus 12 enters a power-saving mode (power-saving state) so as to cause the power supply unit 30 to stop supplying power to the elements (including the controller 26 (host controller 38 and non-host controller 40)) of the image forming apparatus 12. The power supply unit 30 also stops supplying power to the terminal apparatus 14.

The non-host controller 40 includes a terminal D+ and a terminal D−. The terminal D+ is connected to a terminal D2+ of the selector 28 via a data line, while the terminal D− is connected to a terminal D2− of the selector 28 via a data line.

The non-host controller 40 includes a terminal VBUS. The terminal VBUS is connected to the power supply line 36. When the image forming apparatus 12 acts as a non-host device (USB device), power is supplied from the terminal apparatus 14, which acts as a host device (USB host), to the image forming apparatus 12 via the VBUS line 18 of the USB cable 16. This will be discussed later in detail. Power supplied from the terminal apparatus 14 is supplied to the non-host controller 40 via the power supply line 36 and the terminal VBUS. The non-host controller 40 is then driven to control a data sending and receiving operation performed with the terminal apparatus 14.

Operations of the host controller 38 and the non-host controller 40 will be discussed below in detail.

When the image forming apparatus 12 is in a non-power-saving mode (standby state), the host controller 38 outputs a VBUS control signal for turning ON the FET 32 (VBUS control signal indicating a signal level “H”, for example), thereby turning ON the FET 32. This causes the power supply unit 30 to supply power to the elements (including the controller 26) of the image forming apparatus 12. The image forming apparatus 12 thus functions as a host device (USB host). As stated above, the power supply unit 30 is connected to the VBUS line 18 of the USB cable 16 via the FET 32, the diode 34, the power supply line 36, and the connector 24 so as to supply power to the terminal apparatus 14 via these elements. Then, batteries of the terminal apparatus 14 are charged.

When the image forming apparatus 12 is in a power-saving mode (power-saving state), the host controller 38 outputs a VBUS control signal for turning OFF the FET 32 (VBUS control signal indicating a signal level “L”, for example), thereby turning OFF the FET 32. This causes the power supply unit 30 to stop supplying power to the elements (including the controller 26) of the image forming apparatus 12. The image forming apparatus 12 functions as a non-host device (USB device). The power supply unit 30 also stops supplying power to the terminal apparatus 14. In this case, power is supplied from the terminal apparatus 14 to the image forming apparatus 12 via the VBUS line 18 of the USB cable 16, and is then supplied to the non-host controller 40 via the power supply line 36 and the terminal VBUS. The non-host controller 40 is then driven to control a data sending and receiving operation performed with the terminal apparatus 14.

In the example shown in FIG. 1, the diode 34 is disposed between the FET 32 and the connector 24. The anode of the diode 34 is connected to the FET 32, while the cathode is connected to the connector 24. The provision of the diode 34 makes it possible to prevent power supplied from the terminal apparatus 14 to the image forming apparatus 12 from being supplied to the power supply unit 30.

The selector 28 includes a terminal D+ and a terminal D−. The terminal D+ is connected to the data signal line 20 (data signal line D+) of the USB cable 16 via the connector 24, while the terminal D− is connected to the data signal line 22 (data signal line D−) of the USB cable 16 via the connector 24. The selector 28 also includes the terminals D1+ and D1- and the terminals D2+ and D2−. As discussed above, the terminal D1+ of the selector 28 is connected to the terminal D+ of the host controller 38 via a data line, while the terminal D1− of the selector 28 is connected to the terminal D− of the host controller 38 via a data line. The terminal D2+ of the selector 28 is connected to the terminal D+ of the non-host controller 40 via a data line, while the terminal D2− of the selector 28 is connected to the terminal D− of the non-host controller 40 via a data line.

The selector 28 selectively connects the data signal lines 20 and 22 (data signal lines D+ and D−) of the USB cable 16 to one of the host controller 38 and the non-host controller 40. The selector 28 connects the data signal lines 20 and 22 to the host controller 38 by connecting the terminal D+ of the selector 28 to the terminal D1+ and the terminal D− of the selector 28 to the terminal D1−. The state of the image forming apparatus 12 is then switched to a host device. The selector 28 connects the data signal lines 20 and 22 to the non-host controller 40 by connecting the terminal D+ of the selector 28 to the terminal D2+ and the terminal D− of the selector 28 to the terminal D2−. The state of the image forming apparatus 12 is then switched to a non-host device.

The selector 28 includes a terminal S. An identification (ID) signal indicating the state of the image forming apparatus 12 is input into the terminal S as identification information. The selector 28 connects the data signal lines 20 and 22 to one of the host controller 38 and the non-host controller 40 according to this ID signal, thereby switching the state of the image forming apparatus 12 to a host device or a non-host device.

The terminal S is connected to the terminal VBUS EN of the host controller 38 via a data line. A VBUS control signal for turning ON the FET 32 (VBUS control signal indicating a signal level “H”, for example) output from the host controller 38 is input into the selector 28 via the terminal S. This VBUS control signal indicates that the image forming apparatus 12 will act as a host device (USB host) to supply power from the power supply unit 30. Upon receiving this VBUS control signal, the selector 28 connects the data signal lines 20 and 22 to the host controller 38. That is, when the image forming apparatus 12 is in the non-power-saving mode (standby state), the selector 28 connects the data signal lines 20 and 22 to the host controller 38. The image forming apparatus 12 then acts as a host device (USB host).

A VBUS control signal for turning OFF the FET 32 (VBUS control signal indicating a signal level “L”, for example) output from the host controller 38 is input into the selector 28 via the terminal S. This VBUS control signal indicates that the image forming apparatus 12 will act as a non-host device (USB device) to stop supplying power from the power supply unit 30. Upon receiving this VBUS control signal, the selector 28 connects the data signal lines 20 and 22 to the non-host controller 40. That is, when the image forming apparatus 12 is in the power-saving mode (power-saving state), the selector 28 connects the data signal lines 20 and 22 to the non-host controller 40. The image forming apparatus 12 then acts as a non-host device (USB device).

Details of the terminal apparatus 14 will be discussed below.

The terminal apparatus 14 includes a connector 42 which is compliant with the USB standard. The other terminal of the USB cable 16, which is opposite the terminal connected to the connector 24, is connected to the connector 42.

Broadly speaking, the terminal apparatus 14 includes a controller 44 and a power supply unit 46. The controller 44 has a function of controlling the individual elements of the terminal apparatus 14. For example, the controller 44 has a function of controlling a data sending and receiving operation performed with the image forming apparatus 12 via the USB cable 16. The power supply unit 46, which is an example of a second power supply unit, is a power supply device that supplies power to the individual elements of the terminal apparatus 14. The power supply unit 46 also has a function of supplying power to the image forming apparatus 12 via the VBUS line 18 of the USB cable 16. The individual elements of the terminal apparatus 14 will be described below in detail.

The controller 44 includes a USB controller 45. When the terminal apparatus 14 acts as a host device (USB host), the USB controller 45 controls a data sending and receiving operation for a host device according to the USB standard. When the terminal apparatus 14 acts as a non-host device (USB device), the USB controller 45 controls a data sending and receiving operation for a non-host device according to the USB standard. The USB controller 45 functions as a selected one of a USB host IF and a USB non-host IF.

The USB controller 45 includes a terminal D+ and a terminal D−. The terminal D+ is connected to the data signal line 20 (data signal line D+) of the USB cable 16 via the connector 42, while the terminal D− is connected to the data signal line 22 (data signal line D−) of the USB cable 16 via the connector 42.

The USB controller 45 also includes a terminal VBUS. The terminal VBUS is connected to the power supply unit 46 via a FET 48 and a diode 50. The USB controller 45 also includes a terminal VBUS EN for outputting a VBUS control signal. The terminal VBUS EN is connected to the FET 48 via a line. The VBUS line 18 of the USB cable 16 is connected between the diode 50 and the terminal VBUS via the connector 42.

When the image forming apparatus 12 is in the power-saving mode (power-saving state) and acts as a non-host device (USB device), the USB controller 45 is driven by receiving power from the power supply unit 46. The USB controller 45 is thus able to control a data sending and receiving operation performed with the image forming apparatus 12 so as to cause the power supply unit 46 to supply power to the image forming apparatus 12. This enables the terminal apparatus 14 to act as a host device (USB host). When the image forming apparatus 12 is in the non-power-saving mode (standby state) and acts as a host device (USB host), the USB controller 45 causes the power supply unit 46 to stop supplying power to the individual elements (including the USB controller 45) of the terminal apparatus 14. In this case, power is supplied from the image forming apparatus 12, which acts as a host device, to the terminal apparatus 14 via the VBUS line 18 of the USB cable 16, and is then supplied to the USB controller 45 via the terminal VBUS. The USB controller 45 is then driven to control a data sending and receiving operation performed with the image forming apparatus 12. This enables the terminal apparatus 14 to act as a non-host device (USB device).

An operation of the USB controller 45 will now be discussed in detail.

When the image forming apparatus 12 is in the non-power-saving mode (standby state), the USB controller 45 outputs a VBUS control signal for turning OFF the FET 48 (VBUS control signal indicating a signal level “L”, for example), thereby turning OFF the FET 48. This causes the power supply unit 46 to stop supplying power to the elements (including the USB controller 45) of the terminal apparatus 14. In this case, power is supplied from the image forming apparatus 12 to the terminal apparatus 14 via the VBUS line 18 of the USB cable 16, and is then supplied to the USB controller 45 via the terminal VBUS. The USB controller 45 is then driven to control a data sending and receiving operation performed with the image forming apparatus 12. Batteries (power supply unit 46) of the terminal apparatus 14 are also charged by power supplied from the image forming apparatus 12. The terminal apparatus 14 then acts as a non-host device (USB device). Information indicating that the image forming apparatus 12 is in the non-power-saving mode (standby state) may be supplied from the image forming apparatus 12 to the terminal apparatus 14.

When the image forming apparatus 12 is in the power-saving mode (power-saving state), the USB controller 45 outputs a VBUS control signal for turning ON the FET 48 (VBUS control signal indicating a signal level “H”, for example), thereby turning ON the FET 48. This causes the power supply unit 46 to supply power to the elements (including the USB controller 45) of the terminal apparatus 14. As stated above, the power supply unit 46 is connected to the VBUS line 18 of the USB cable 16 via the FET 48, the diode 50, the power supply line, and the connector 42 so as to supply power to the image forming apparatus 12 via these elements. The terminal apparatus 14 then acts as a host device (USB host). Information indicating that the image forming apparatus 12 is in the power-saving mode (power-saving state) may be sent from the image forming apparatus 12 to the terminal apparatus 14.

An operation of the information processing system 10 according to the first exemplary embodiment will be described below in detail.

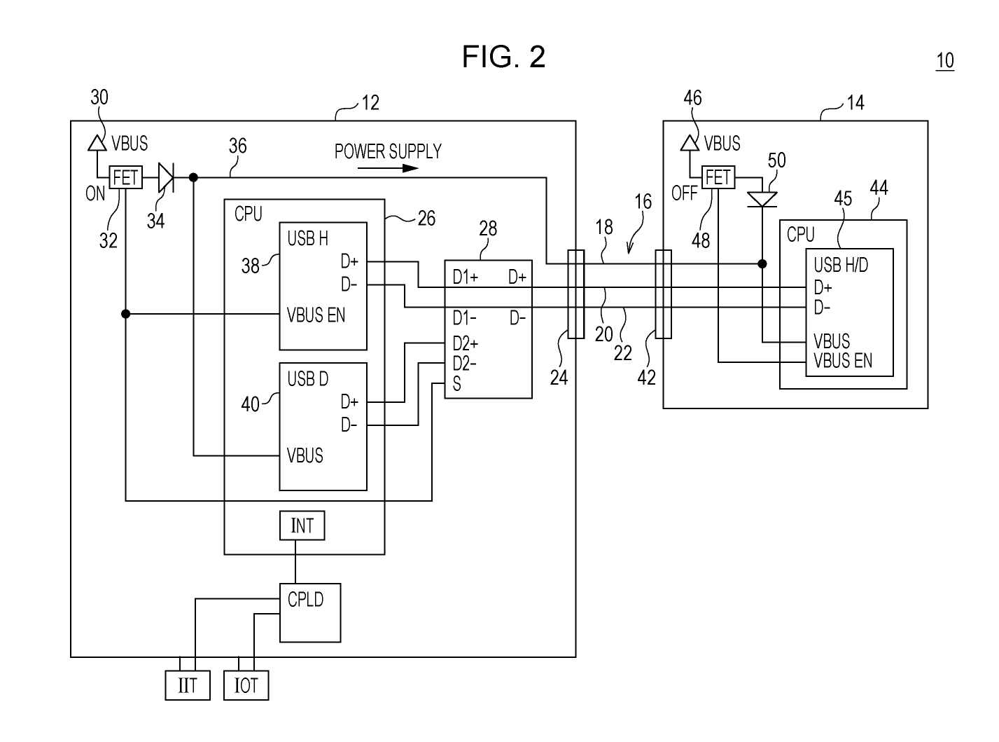

The operation of the information processing system 10 when the image forming apparatus 12 is in the non-power-saving mode (standby state) will be described below with reference to FIG. 2. FIG. 2 illustrates the configuration of the information processing system 10 when the image forming apparatus 12 is in the non-power-saving mode.

When the image forming apparatus 12 is in the non-power-saving mode (standby state), the host controller 38 outputs a VBUS control signal for turning ON the FET 32 (VBUS control signal indicating a signal level “H”, for example), thereby turning ON the FET 32. This causes the power supply unit 30 to supply power to the elements (including the controller 26) of the image forming apparatus 12. The VBUS control signal is also input into the selector 28 via the terminal S. The level of the VBUS control signal is “H”, that is, the VBUS control signal indicates that the image forming apparatus 12 will act as a host device (USB host). Upon receiving this VBUS control signal, the selector 28 connects the data signal lines 20 and 22 to the host controller 38. The image forming apparatus 12 then acts as a host device. The host controller 38 is driven by power supplied from the power supply unit 30 so as to send and receive data to and from the terminal apparatus 14 via the selector 28 and the USB cable 16. Power from the power supply unit 30 is also supplied to the terminal apparatus 14 via the FET 32, the diode 34, the power supply line 36, the connector 24, and the VBUS line 18 of the USB cable 16.

When power is supplied from the image forming apparatus 12 to the terminal apparatus 14, the USB controller 45 of the terminal apparatus 14 outputs a VBUS control signal for turning OFF the FET 48 (VBUS control signal indicating a signal level “L”, for example), thereby turning OFF the FET 48. This causes the power supply unit 46 to stop supplying power to the elements (including the USB controller 45) of the terminal apparatus 14. Power is supplied from the image forming apparatus 12 to the terminal apparatus 14 via the VBUS line 18 of the USB cable 16, and is then supplied to the USB controller 45 via the terminal VBUS. The USB controller 45 is then driven to send and receive data to and from the image forming apparatus 12. This enables the terminal apparatus 14 to act as a non-host device (USB device). Batteries (power supply unit 46) of the terminal apparatus 14 are also charged by power supplied from the image forming apparatus 12.

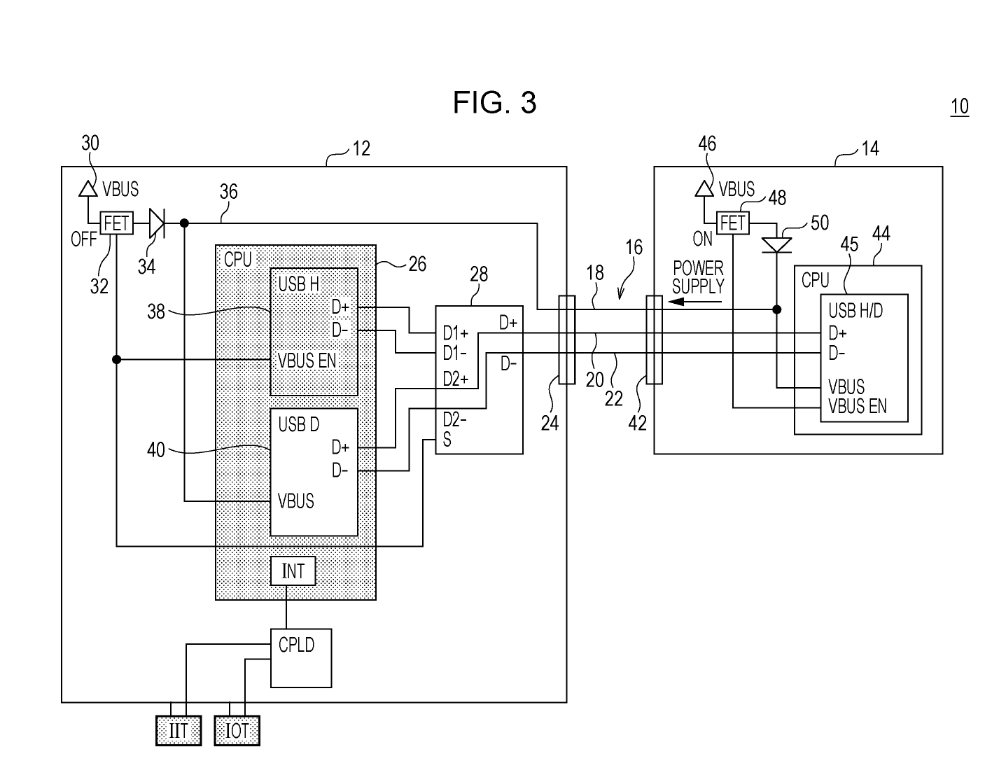

The operation of the information processing system 10 when the image forming apparatus 12 is in the power-saving mode (power-saving state) will be described below with reference to FIG. 3. FIG. 3 illustrates the configuration of the information processing system 10 when the image forming apparatus 12 is in the power-saving mode.

It is assumed that the image forming apparatus 12 is now in the non-power-saving mode. In this case, if the image forming apparatus 12 does not perform any processing, such as image forming processing, for a predetermined period or if an instruction to shift to the power-saving mode is provided from a user, the host controller 38 causes the image forming apparatus 12 to enter the power-saving mode (power-saving state). An instruction to shift to the power-saving mode may be provided via the user interface of the image forming apparatus 12 or the user interface of the terminal apparatus 14. For example, if the user provides an instruction to shift to the power-saving mode by using the terminal apparatus 14 when the image forming apparatus 12 is in the non-power-saving mode, information indicating this instruction is sent from the terminal apparatus 14 to the image forming apparatus 12 via the USB cable 16. The host controller 38 receives this information and causes the image forming apparatus 12 to shift to the power-saving mode.

When the image forming apparatus 12 is in the power-saving mode (power-saving state), the host controller 38 outputs a VBUS control signal for turning OFF the FET 32 (VBUS control signal indicating a signal level “L”, for example), thereby turning OFF the FET 32. This causes the power supply unit 30 to stop supplying power to the elements (including the controller 26) of the image forming apparatus 12. The power supply unit 30 also stops supplying power to the terminal apparatus 14. The VBUS control signal is also input into the selector 28 via the terminal S. The level of the VBUS control signal is “L”, that is, the VBUS control signal indicates that the image forming apparatus 12 will act as a non-host device (USB device). Upon receiving this VBUS control signal, the selector 28 connects the data signal lines 20 and 22 to the non-host controller 40. This enables the image forming apparatus 12 to act as a non-host device (USB device).

When power supply from the image forming apparatus 12 to the terminal apparatus 14 has stopped, the USB controller 45 of the terminal apparatus 14 outputs a VBUS control signal for turning ON the FET 48 (VBUS control signal indicating a signal level “H”, for example), thereby turning ON the FET 48. This causes the power supply unit 46 to supply power to the elements (including the controller 44) of the terminal apparatus 14. The USB controller 45 is then driven by power supplied from the power supply unit 46 so as to send and receive data to and from the image forming apparatus 12. Power from the power supply unit 46 is also supplied to the image forming apparatus 12 via the FET 48, the diode 50, the power supply line, the connector 42, and the VBUS line 18 of the USB cable 16. The terminal apparatus 14 acts as a host device (USB host) in this manner.

Power is supplied from the terminal apparatus 14 to the image forming apparatus 12 via the VBUS line 18 of the USB cable 16, and is then supplied to the non-host controller 40 via the power supply line 36 and the terminal VBUS. The non-host controller 40 is then driven to send and receive data to and from the terminal apparatus 14.

When the image forming apparatus 12 is in the power-saving mode, if the user operates the terminal apparatus 14 to send an instruction to shift back to the non-power-saving state from the power-saving state, information indicating a request to shift back to the non-power-saving state is sent from the terminal apparatus 14 to the image forming apparatus 12 via the USB cable 16. Upon receiving this information, the selector 28 connects the data signal lines 20 and 22 to the host controller 38. The host controller 38 outputs a VBUS control signal for turning ON the FET 32 (VBUS control signal indicating a signal level “H”, for example), thereby turning ON the FET 32. This causes the power supply unit 30 to supply power to the elements of the image forming apparatus 12, so that the image forming apparatus 12 can shift from the power-saving mode (power-saving state) to the non-power-saving mode (standby state). The image forming apparatus 12 then acts as a host device (USB host). Power is also supplied from the image forming apparatus 12 to the terminal apparatus 14. The USB controller 45 of the terminal apparatus 14 turns OFF the FET 48 so as to cause the power supply unit 46 to stop supplying power to the elements of the terminal apparatus 14. This enables the terminal apparatus 14 to act as a non-host device (USB device). The USB controller 45 is driven by power supplied from the image forming apparatus 12. In this manner, when information indicating a request to shift back to the non-power-saving state from the power-saving state is sent from the terminal apparatus 14 to the image forming apparatus 12, the image forming apparatus 12 shifts back to the non-power-saving state and acts as a host device, and the terminal apparatus 14 acts as a non-host device.

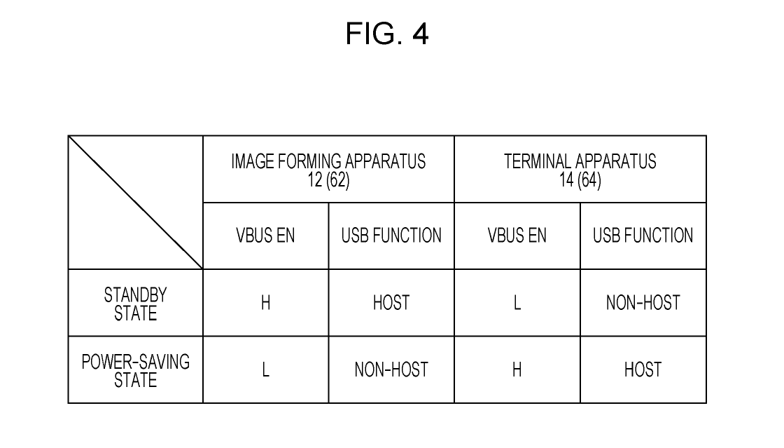

FIG. 4 is a state transition table indicating the states of the image forming apparatus 12 and the terminal apparatus 14. The above-described operations of the information processing system 10 are reflected in the state transition table. When the image forming apparatus 12 is in the standby state (non-power-saving mode), the level of the VBUS control signal output from the image forming apparatus 12 is “H”, and the image forming apparatus 12 acts as a host device (USB host). In the terminal apparatus 14, the level of the VBUS control signal is “L”, and the terminal apparatus 14 acts as a non-host device (USB device). When the image forming apparatus 12 is in the power-saving state (power-saving mode), the level of the VBUS control signal output from the image forming apparatus 12 is “L”, and the image forming apparatus 12 acts as a non-host device (USB device). In the terminal apparatus 14, the level of the VBUS control signal is “H”, and the terminal apparatus 14 acts as a host device (USB host).

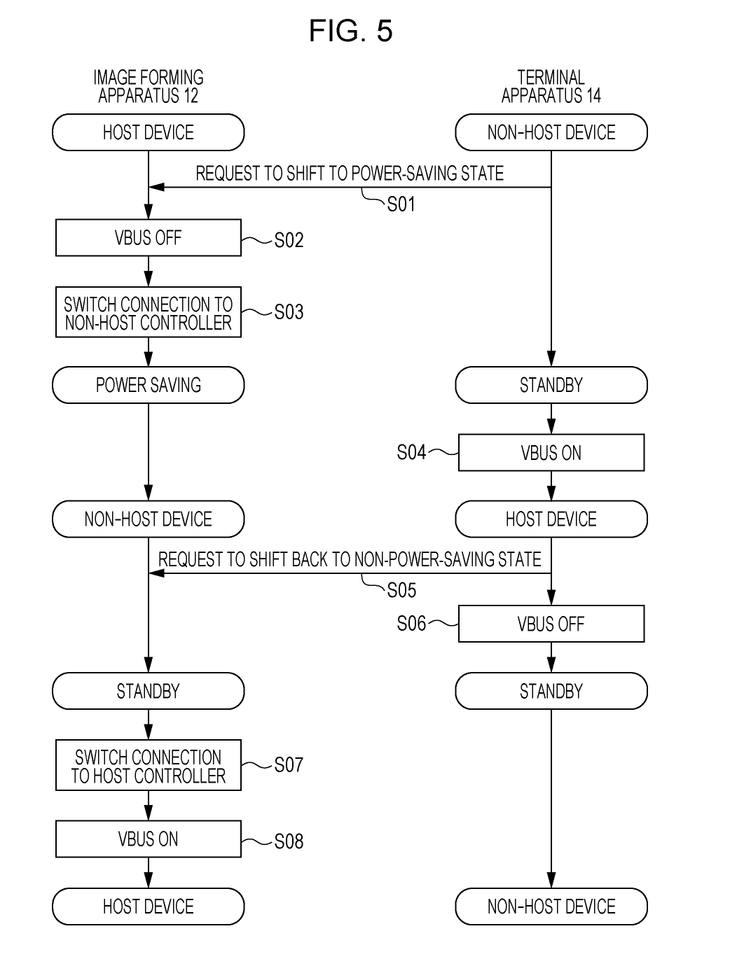

The operation of the information processing system 10 will be described below with reference to the sequence diagram of FIG. 5.

It is assumed that the image forming apparatus 12 now acts as a host device (USB host) and the terminal apparatus 14 now acts as a non-host device (USB device). In this state, a user operates the terminal apparatus 14 to provide an instruction to cause the image forming apparatus 12 to shift to the power-saving state. Then, information indicating a request to shift to the power-saving state is sent from the terminal apparatus 14 to the image forming apparatus 12 via the USB cable 16 (S01).

Upon receiving this information from the terminal apparatus 14, the host controller 38 of the image forming apparatus 12 causes the power supply unit 30 to stop supplying power (VBUS OFF) (S02). The selector 28 connects the data signal lines 20 and 22 to the non-host controller 40 (to a USB device) (S03). Then, the image forming apparatus 12 can shift to the power-saving mode (power-saving state) and act as a non-host device (USB device).

The USB controller 45 of the terminal apparatus 14 causes the power supply unit 46 to supply power to the elements of the terminal apparatus 14 (VBUS ON) (S04). Power is then supplied from the terminal apparatus 14 to the image forming apparatus 12 via the USB cable 16 so that the non-host controller 40 can be driven. The terminal apparatus 14 then acts as a host device (USB host).

Thereafter, if the user operates the terminal apparatus 14 to provide an instruction to cause the image forming apparatus 12 to shift back to the non-power-saving state from the power-saving state, information indicating a request to shift back to the non-power-saving state is sent from the terminal apparatus 14 to the image forming apparatus 12 via the USB cable 16 (S05).

The USB controller 45 of the terminal apparatus 14 causes the power supply unit 46 to stop supplying power (VBUS OFF) (S06). The terminal apparatus 14 then acts as a non-host device (USB device).

Upon receiving information indicating a request to shift back to the non-power-saving state from the terminal apparatus 14, the selector 28 of the image forming apparatus 12 connects the data signal lines 20 and 22 to the host controller 38 (to a USB host) (S07). The host controller 38 causes the power supply unit 30 to supply power to the elements of the image forming apparatus 12 (VBUS ON) (S08). The image forming apparatus 12 then acts as a host device (USB host). Power from the power supply unit 30 is also supplied from the image forming apparatus 12 to the terminal apparatus 14.

In the first exemplary embodiment, the image forming apparatus 12 includes the host controller 38, the non-host controller 40, and the selector 28. In accordance with the state of the image forming apparatus 12 (the power-saving state or the standby state), the selector 28 selectively connects the USB cable 16 to one of the host controller 38 and the non-host controller 40. This makes it possible to dynamically switch the states of the image forming apparatus 12 and the terminal apparatus 14 between a host device and a non-host device even if one of the image forming apparatus 12 and the terminal apparatus 14 (image forming apparatus 12, for example) is not a dual-role device. This can be achieved without physically connecting the USB cable 16 to the host controller 38 or the non-host controller 40.

When the image forming apparatus 12 is in the power-saving mode, the power supply unit 30 stops supplying power to the elements of the image forming apparatus 12, and the non-host controller 40 is driven by power supplied from the terminal apparatus 14. It is thus possible to reduce power consumed in the image forming apparatus 12.

After the image forming apparatus 12 shifts to the power-saving mode, the terminal apparatus 14 acts as a host device (USB host). The terminal apparatus 14 can thus provide a request to shift back to the non-power-saving state from the power-saving state to the image forming apparatus 12. This enables the image forming apparatus 12 to shift back to the non-power-saving mode (standby state).

When the image forming apparatus 12 is in the power-saving mode, if the terminal apparatus 14 receives a job, such as a print job, it may send information indicating a request to shift back to the non-power-saving state from the power-saving state to the image forming apparatus 12. Then, in response to a job received by the terminal apparatus 14, the image forming apparatus 12 can shift back to the standby state from the power-saving state and execute the job.

When the image forming apparatus 12 is in the power-saving mode, if the charging level in the power supply source (power supply unit 46) of the terminal apparatus 14 becomes lower than a predetermined threshold, the terminal apparatus 14 may send information indicating a request to shift back to the non-power-saving state from the power-saving state to the image forming apparatus 12. This makes it possible to avoid a situation where power supplied from the terminal apparatus 14 is running low and the image forming apparatus 12 is unable to shift back to the standby state from the power-saving state. If the charging level in the power supply source of the terminal apparatus 14 becomes lower than the predetermined threshold, the controller 44 of the terminal apparatus 14 may display alarm information on the user interface of the terminal apparatus 14. The controller 44 may alternatively output alarm sound or cause a light source provided in the terminal apparatus 14 to blink. The user is then informed that power is running low in the terminal apparatus 14.

Each of the image forming apparatus 12 and the terminal apparatus 14 may be implemented as a result of software and hardware operating together. More specifically, each of the image forming apparatus 12 and the terminal apparatus 14 includes one or plural processors, such as central processing units (CPUs), which are not shown. As a result of this processor or these processors reading and executing a program stored in a storage device, which is not shown, the functions of the image forming apparatus 12 and the terminal apparatus 14 are achieved. This program is stored in a storage device by using a recording medium, such as a compact disc (CD) or a digital versatile disc (DVD), or via a communication path, such as a network. In the example shown in FIG. 1, each of the controller 26 of the image forming apparatus 12 and the controller 44 of the terminal apparatus 14 is constituted by one or plural CPUs. Alternatively, the functions of the image forming apparatus 12 and the terminal apparatus 14 may be achieved by using hardware resources, such as a processor, an electronic circuit, and an application specific integrated circuit (ASIC). In this case, a device, such as a memory, may be used. Alternatively, the functions of the image forming apparatus 12 and the terminal apparatus 14 may be achieved by using a digital signal processor (DSP) or a field programmable gate array (FPGA). For example, in the image forming apparatus 12, the host controller 38 may be constituted by a CPU and the non-host controller 40 may be constituted by an ASIC.

### Second Exemplary Embodiment

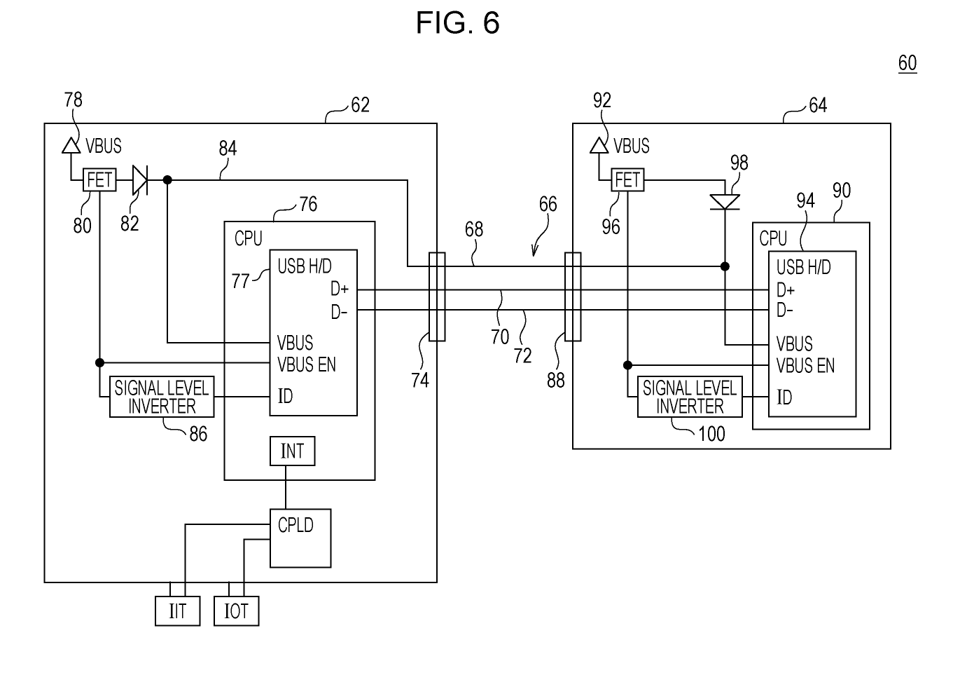

An information processing system 60 according to a second exemplary embodiment of the invention will be described below with reference to FIG. 6. FIG. 6 illustrates an example of the information processing system 60.

The information processing system 60 includes an image forming apparatus 62 which serves as a first device and a terminal apparatus 64 which serves as a second device. The image forming apparatus 62 and the terminal apparatus 64 are connected to each other via a USB cable 66 compliant with the USB standard. The image forming apparatus 62 and the terminal apparatus 64 send and receive data to and from each other via the USB cable 66. The image forming apparatus 62 corresponds to an example of an information processing apparatus, while the terminal apparatus 64 corresponds to an example of an external apparatus.

An overview of the image forming apparatus 62, the terminal apparatus 64, and the USB cable 66 will be described below.

The image forming apparatus 62 has an image forming function, and more specifically, at least one of a print function, a scan function, a copy function, and a fax function, for example. Upon receiving a control signal concerning image forming processing (for example, a job, such as a print job), the image forming apparatus 62 forms an image in accordance with the control signal. The control signal (job) may be sent to the image forming apparatus 62 from the terminal apparatus 64 via the USB cable 66 or from a device other than the terminal apparatus 64. The image forming apparatus 62 may have a function of performing wired communication according to a communication standard other than the USB standard or a function of performing wireless communication (such as Wi-Fi communication and Bluetooth communication). The image forming apparatus 62 may perform processing other than image forming processing. The image forming apparatus 62 may have a user interface. The user interface includes a display and an operation unit, for example. The display is a display device, such as a liquid crystal display, and the operation unit is an input device, such as an operation panel or a keyboard. The user interface may be a device which serves as both of a display and an operation unit (a touch panel display, for example).

The terminal apparatus 64 is a PC or a mobile terminal such as a smartphone, a tablet PC, or a cellular phone. The terminal apparatus 64 has a user interface. The user interface includes a display and an operation unit, for example. The display is a display device, such as a liquid crystal display, and the operation unit is an input device, such as an operation panel or a keyboard. The user interface may be a device which serves as both of a display and an operation unit (a touch panel display, for example). The terminal apparatus 64 may have a function of performing wired communication according to a communication standard other than the USB standard or a function of performing wireless communication (such as Wi-Fi communication and Bluetooth communication). When being connected to the image forming apparatus 62 via the USB cable 66, the terminal apparatus 64 may be used as a user interface of the image forming apparatus 62. In this case, a menu screen concerning a function of the image forming apparatus 62 (an image forming function, for example) is displayed on the user interface of the terminal apparatus 64, and a user provides an instruction to execute image forming processing by using this menu screen, for example. The terminal apparatus 64 may receive a job from another device and send this job to the image forming apparatus 62 via the USB cable 66 or another communication path.

The image forming apparatus 62 is only an example of the first device, and the terminal apparatus 64 is only an example of the second device. The first device may be another device (a PC, for example) other than the image forming apparatus 62, and the second device may be another device (a digital camera, for example) other than the terminal apparatus 64.

In the information processing system 60 according to the second exemplary embodiment, one of the image forming apparatus 62 and the terminal apparatus 64 functions as a host device (USB host) and the other one functions as a non-host device (USB device or peripheral). When the image forming apparatus 62 functions as a host device, the terminal apparatus 64 functions as a non-host device. When the image forming apparatus 62 functions as a non-host device, the terminal apparatus 64 functions as a host device.

As in the USB cable 16 of the first exemplary embodiment, the USB cable 66 includes a VBUS (power supply bus) line 68, which serves as a power supply line, and two data signal lines (D+ data signal line 70 and D− data signal line 72), which serve as data lines. Power is supplied to the VBUS line 68 from a host device and is then supplied to a non-host device via the VBUS line 68. Differential signaling is performed in the data signal lines 70 and 72.

Details of the image forming apparatus 62 will be discussed below.

The image forming apparatus 62 includes a connector 74 which is compliant with the USB standard. One terminal of the USB cable 66 is connected to the connector 74.

Broadly speaking, the image forming apparatus 62 includes a controller 76 and a power supply unit 78. The controller 76 has a function of controlling the individual elements of the image forming apparatus 62. For example, the controller 76 has a function of controlling a data sending and receiving operation performed with the terminal apparatus 64 via the USB cable 66. The power supply unit 78, which is an example of a first power supply unit, is a power supply device that supplies power to the individual elements of the image forming apparatus 62. The power supply unit 78 is connected to the VBUS line 68 of the USB cable 66 via a FET 80, a diode 82, a power supply line 84, and the connector 74 so as to supply power to the terminal apparatus 64 via these elements. Details of the individual elements of the image forming apparatus 62 will be discussed below.

The controller 76 includes a USB controller 77. When the image forming apparatus 62 acts as a host device (USB host), the USB controller 77 controls a data sending and receiving operation for a host device according to the USB standard. When the image forming apparatus 62 acts as a non-host device (USB device), the USB controller 77 controls a data sending and receiving operation for a non-host device according to the USB standard. The USB controller 77 also serves as an example of a switching unit, and switches the state of the image forming apparatus 62 to a host device or a non-host device according to an ID signal indicating whether the image forming apparatus 62 acts as a host device or a non-host device. The USB controller 77 functions as a selected one of a USB host IF and a USB non-host IF.

The USB controller 77 includes a terminal D+ and a terminal D−. The terminal D+ is connected to the data signal line 70 (data signal line D+) of the USB cable 66 via a data line and the connector 74, while the terminal D− is connected to the data signal line 72 (data signal line D−) of the USB cable 66 via a data line and the connector 74.

The USB controller 77 also includes a terminal VBUS EN from which a VBUS control signal is output. The terminal VBUS EN is connected to the FET 80 via a line. When the image forming apparatus 62 acts as a host device (USB host), the USB controller 77 is driven by receiving power supplied from the power supply unit 78 so as to control a data sending and receiving operation performed with the terminal apparatus 64 and to cause the power supply unit 78 to supply power to the terminal apparatus 64. When the image forming apparatus 62 acts as a non-host device (USB device), the USB controller 77 causes the power supply unit 78 to stop supplying power. Then, the image forming apparatus 62 enters the power-saving mode (power-saving state) so as to cause the power supply unit 78 to stop supplying power to the elements (including the controller 76) of the image forming apparatus 62. The power supply unit 78 also stops supplying power to the terminal apparatus 64.

The USB controller 77 includes a terminal VBUS. The terminal VBUS is connected to the power supply line 84. When the image forming apparatus 62 acts as a non-host device (USB device), power is supplied from the terminal apparatus 64, which acts as a host device (USB host), to the image forming apparatus 62 via the VBUS line 68 of the USB cable 66. This will be discussed later in detail. Power supplied from the terminal apparatus 64 is supplied to the USB controller 77 via the power supply line 84 and the terminal VBUS. The USB controller 77 is then driven so as to control a data sending and receiving operation performed with the terminal apparatus 64.

When the image forming apparatus 62 is in the non-power-saving mode (standby state), the USB controller 77 outputs a VBUS control signal for turning ON the FET 80 (VBUS control signal indicating a signal level “H”, for example), thereby turning ON the FET 80. This causes the power supply unit 78 to supply power to the elements (including the controller 76) of the image forming apparatus 62. The image forming apparatus 62 then acts as a host device (USB host). As stated above, the power supply unit 78 is connected to the VBUS line 68 of the USB cable 66 via the FET 80, the diode 82, the power supply line 84, and the connector 74 so as to supply power to the terminal apparatus 64 via these elements. Then, batteries of the terminal apparatus 64 are charged.

When the image forming apparatus 62 is in the power-saving mode (power-saving state), the USB controller 77 outputs a VBUS control signal for turning OFF the FET 80 (VBUS control signal indicating a signal level “L”, for example), thereby turning OFF the FET 80. This causes the power supply unit 78 to stop supplying power to the elements (including the controller 76) of the image forming apparatus 62. The image forming apparatus 62 then acts as a non-host device (USB device). The power supply unit 78 also stops supplying power to the terminal apparatus 64. In this case, power is supplied from the terminal apparatus 64 to the image forming apparatus 62 via the VBUS line 68 of the USB cable 66, and is then supplied to the USB controller 77 via the power supply line 84 and the terminal VBUS. The USB controller 77 is then driven so as to control a data sending and receiving operation performed with the terminal apparatus 64.

In the example shown in FIG. 6, the diode 82 is disposed between the FET 80 and the connector 74. The anode of the diode 82 is connected to the FET 80, while the cathode is connected to the connector 74. The provision of the diode 82 makes it possible to prevent power supplied from the terminal apparatus 64 to the image forming apparatus 62 from being supplied to the power supply unit 78.

The USB controller 77 includes a terminal ID. An ID signal indicating the state of the image forming apparatus 62 is input into the terminal ID as identification information. The USB controller 77 switches the state of the image forming apparatus 62 to a host device or a non-host device according to the ID signal.

The terminal ID is connected to the terminal VBUS EN of the USB controller 77 via a data line and a signal level inverter 86. The signal level inverter 86 has a function of inverting the level of a signal.

When a VBUS control signal for turning ON the FET 80 (VBUS control signal indicating a signal level “H”, for example) is output from the USB controller 77, the level of the VBUS control signal is inverted by the signal level inverter 86. The inverted VBUS control signal (VBUS control signal indicating a signal level “L”, for example) is input into the USB controller 77 via the terminal ID as an ID signal. This VBUS control signal indicates that the image forming apparatus 62 will act as a host device (USB host) and supply power from the power supply unit 78. Upon receiving this VBUS control signal, the USB controller 77 switches the state of the image forming apparatus 62 to a host device (USB host). That is, when the image forming apparatus 62 is in the non-power-saving mode (standby state), the USB controller 77 switches the state of the image forming apparatus 62 to a host device.

When a VBUS control signal for turning OFF the FET 80 (VBUS control signal indicating a signal level “L”, for example) is output from the USB controller 77, the level of the VBUS control signal is inverted by the signal level inverter 86. The inverted VBUS control signal (VBUS control signal indicating a signal level “H”, for example) is input into the USB controller 77 via the terminal ID as an ID signal. This VBUS control signal indicates that the image forming apparatus 62 will act as a non-host device (USB device) and stop supplying power from the power supply unit 78. Upon receiving this VBUS control signal, the USB controller 77 switches the state of the image forming apparatus 62 to a non-host device (USB device). That is, when the image forming apparatus 62 is in the power-saving mode (power-saving state), the USB controller 77 switches the state of the image forming apparatus 62 to a non-host device.

In the example shown in FIG. 6, the signal level inverter 86 is used for inverting the level of a VBUS control signal. However, instead of using the signal level inverter 86, a VBUS control signal may be used as an ID signal. In this case, a VBUS control signal at a signal level “H” is information indicating that the image forming apparatus 62 will act as a host device, while a VBUS control signal at a signal level “L” is information indicating that the image forming apparatus 62 will act as a non-host device.

Details of the terminal apparatus 64 will be discussed below.

The terminal apparatus 64 includes a connector 88 compliant with the USB standard. The other terminal of the USB cable 66, which is opposite the terminal connected to the connector 74, is connected to the connector 88.

Broadly speaking, the terminal apparatus 64 includes a controller 90 and a power supply unit 92. The controller 90 has a function of controlling the individual elements of the terminal apparatus 64. For example, the controller 90 has a function of controlling a data sending and receiving operation performed with the image forming apparatus 62 via the USB cable 66. The power supply unit 92, which is an example of a second power supply unit, is a power supply device that supplies power to the individual elements of the terminal apparatus 64. The power supply unit 92 also has a function of supplying power to the image forming apparatus 62 via the VBUS line 68 of the USB cable 66. The individual elements of the terminal apparatus 64 will be described below in detail.

The controller 90 includes a USB controller 94. When the terminal apparatus 64 acts as a host device (USB host), the USB controller 94 controls a data sending and receiving operation for a host device according to the USB standard. When the terminal apparatus 64 acts as a non-host device (USB device), the USB controller 94 controls a data sending and receiving operation for a non-host device according to the USB standard. The USB controller 94 functions as a selected one of a USB host IF and a USB non-host IF.

The USB controller 94 includes a terminal D+ and a terminal D−. The terminal D+ is connected to the data signal line 70 (data signal line D+) of the USB cable 66 via the connector 88, while the terminal D− is connected to the data signal line 72 (data signal line D−) of the USB cable 66 via the connector 88.

The USB controller 94 also includes a terminal VBUS. The terminal VBUS is connected to the power supply unit 92 via a FET 96 and a diode 98. The USB controller 94 also includes a terminal VBUS EN for outputting a VBUS control signal. The terminal VBUS EN is connected to the FET 96 via a line. The VBUS line 68 of the USB cable 66 is connected between the diode 98 and the terminal VBUS via the connector 88.

When the image forming apparatus 62 acts as a non-host device (USB device), the USB controller 94 is driven by receiving power from the power supply unit 92 so as to control a data sending and receiving operation performed with the image forming apparatus 62 and to cause the power supply unit 92 to supply power to the image forming apparatus 62. This enables the terminal apparatus 64 to act as a host device (USB host). When the image forming apparatus 62 acts as a host device (USB host), the USB controller 94 causes the power supply unit 92 to stop supplying power to the individual elements (including the USB controller 94) to the terminal apparatus 64. In this case, power is supplied from the image forming apparatus 62, which acts as a host device, to the terminal apparatus 64 via the VBUS line 68 of the USB cable 66, and is then supplied to the USB controller 94 via the terminal VBUS. The USB controller 94 is then driven to control a data sending and receiving operation performed with the image forming apparatus 62. This enables the terminal apparatus 64 to act as a non-host device (USB device).

When the image forming apparatus 62 is in the non-power-saving mode (standby state), the USB controller 94 outputs a VBUS control signal for turning OFF the FET 96 (VBUS control signal indicating a signal level “L”, for example), thereby turning OFF the FET 96. This causes the power supply unit 92 to stop supplying power to the elements (including the USB controller 94) of the terminal apparatus 64. In this case, power is supplied from the image forming apparatus 62 to the terminal apparatus 64 via the VBUS line 68 of the USB cable 66, and is then supplied to the USB controller 94 via the terminal VBUS. The USB controller 94 is then driven to control a data sending and receiving operation performed with the image forming apparatus 62. Batteries (power supply unit 92) of the terminal apparatus 64 are also charged by power supplied from the image forming apparatus 62. The terminal apparatus 64 functions as a non-host device (USB device) in this manner.

When the image forming apparatus 62 is in the power-saving mode (power-saving state), the USB controller 94 outputs a VBUS control signal for turning ON the FET 96 (VBUS control signal indicating a signal level “H”, for example), thereby turning ON the FET 96. This causes the power supply unit 92 to supply power to the elements (including the USB controller 94) of the terminal apparatus 64. As stated above, the power supply unit 92 is connected to the VBUS line 68 of the USB cable 66 via the FET 96, the diode 98, the power supply line, and the connector 88 so as to supply power to the image forming apparatus 62 via these elements. The terminal apparatus 64 functions as a host device (USB host) in this manner.

The USB controller 94 includes a terminal ID. An ID signal indicating the state of the terminal apparatus 64 is input into the terminal ID as identification information. The USB controller 94 switches the state of the terminal apparatus 64 to a host device or a non-host device according to the ID signal.

The terminal ID is connected to the terminal VBUS EN of the USB controller 94 via a data line and a signal level inverter 100. The signal level inverter 100 has a function of inverting the level of a signal.

When a VBUS control signal for turning ON the FET 96 (VBUS control signal indicating a signal level “H”, for example) is output from the USB controller 94, the level of the VBUS control signal is inverted by the signal level inverter 100. The inverted VBUS control signal (VBUS control signal indicating a signal level “L”, for example) is input into the USB controller 94 via the terminal ID as an ID signal. This VBUS control signal indicates that the terminal apparatus 64 will act as a host device (USB host) and supply power from the power supply unit 92. Upon receiving this VBUS control signal, the USB controller 94 switches the state of the terminal apparatus 64 to a host device (USB host). That is, when the image forming apparatus 62 is in the power-saving mode (power-saving state), the USB controller 94 switches the state of the terminal apparatus 64 to a host device (USB host).

When a VBUS control signal for turning OFF the FET 96 (VBUS control signal indicating a signal level “L”, for example) is output from the USB controller 94, the level of the VBUS control signal is inverted by the signal level inverter 100. The inverted VBUS control signal (VBUS control signal indicating a signal level “H”, for example) is input into the USB controller 94 via the terminal ID as an ID signal. This VBUS control signal indicates that the terminal apparatus 64 will act as a non-host device (USB device) and stop supplying power from the power supply unit 92. Upon receiving this VBUS control signal, the USB controller 94 switches the state of the terminal apparatus 64 to a non-host device (USB device). That is, when the image forming apparatus 62 is in the non-power-saving mode (standby state), the USB controller 94 switches the state of the terminal apparatus 64 to a non-host device.

In the example shown in FIG. 6, the signal level inverter 100 is used for inverting the level of a VBUS control signal. However, instead of using the signal level inverter 100, a VBUS control signal may be used as an ID signal. In this case, a VBUS control signal at a signal level “H” is information indicating that the terminal apparatus 64 will act as a host device, while a VBUS control signal at a signal level “L” is information indicating that the terminal apparatus 64 will act as a non-host device.

An operation of the information processing system 60 according to the second exemplary embodiment will be described below in detail.

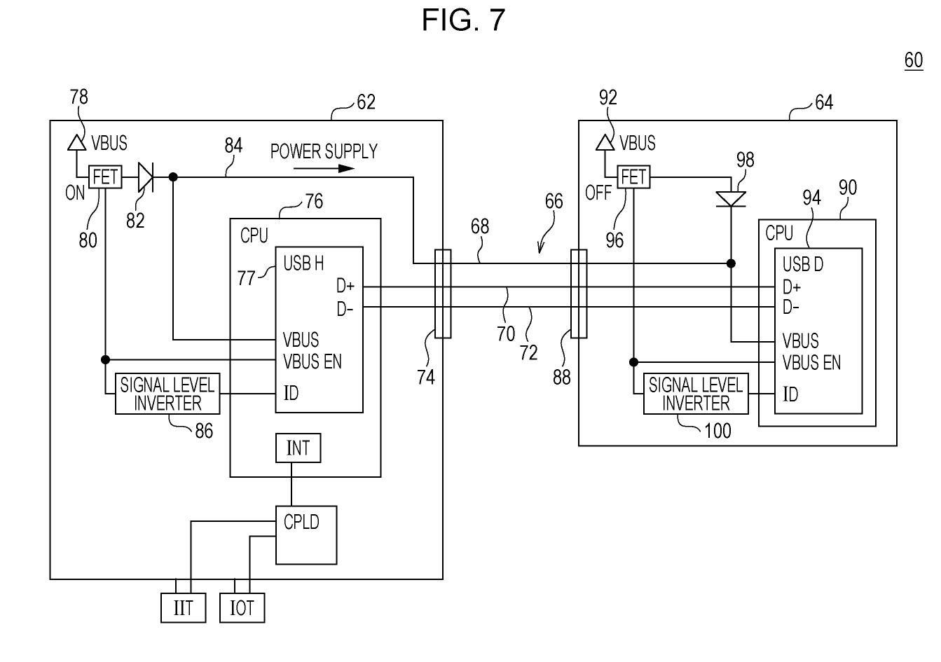

The operation of the information processing system 60 when the image forming apparatus 62 is in the non-power-saving mode (standby state) will be described below with reference to FIG. 7. FIG. 7 illustrates the configuration of the information processing system 60 when the image forming apparatus 62 is in the non-power-saving mode.

When the image forming apparatus 62 is in the non-power-saving mode (standby state), the USB controller 77 outputs a VBUS control signal for turning ON the FET 80 (VBUS control signal indicating a signal level “H”, for example), thereby turning ON the FET 80. This causes the power supply unit 78 to supply power to the elements (including the controller 76) of the image forming apparatus 62. The image forming apparatus 62 then functions as a host device (USB host).

The VBUS control signal is inverted by the signal level inverter 86 and is input into the USB controller 77 via the terminal ID as an ID signal. The level of the inverted VBUS control signal (ID signal) is “L”, that is, the VBUS control signal indicates that the image forming apparatus 62 will act as a host device (USB host). Upon receiving this ID signal, the USB controller 77 identifies based on the ID signal that the image forming apparatus 62 is a host device (USB host) and controls a data sending and receiving operation for a host device. In this case, the USB controller 77 is driven by power supplied from the power supply unit 78 to send and receive data to and from the terminal apparatus 64 via the USB cable 66.

Power from the power supply unit 78 is also supplied to the terminal apparatus 64 via the FET 80, the diode 82, the power supply line 84, the connector 74, and the VBUS line 68 of the USB cable 66.

When power is supplied from the image forming apparatus 62 to the terminal apparatus 64, the USB controller 94 of the terminal apparatus 64 outputs a VBUS control signal for turning OFF the FET 96 (VBUS control signal indicating a signal level “L”, for example), thereby turning OFF the FET 96. This causes the power supply unit 92 to stop supplying power to the elements (including the USB controller 94) of the terminal apparatus 64. Power is supplied from the image forming apparatus 62 to the terminal apparatus 64 via the VBUS line 68 of the USB cable 66, and is then supplied to the USB controller 94 via the terminal VBUS. The USB controller 94 is then driven to send and receive data to and from the image forming apparatus 62. This enables the terminal apparatus 64 to act as a non-host device (USB device). Batteries (power supply unit 92) of the terminal apparatus 64 are also charged by power supplied from the image forming apparatus 62.

The VBUS control signal is inverted by the signal level inverter 100 and is input into the USB controller 94 via the terminal ID as an ID signal. The level of the inverted VBUS control signal (ID signal) is “H”, that is, the VBUS control signal indicates that the terminal apparatus 64 will act as a non-host device (USB device). Upon receiving this ID signal, the USB controller 94 identifies based on the ID signal that the terminal apparatus 64 is a non-host device and controls a data sending and receiving operation for a non-host device. In this case, the USB controller 94 is driven by power supplied from the image forming apparatus 62 to send and receive data to and from the image forming apparatus 62 via the USB cable 66.

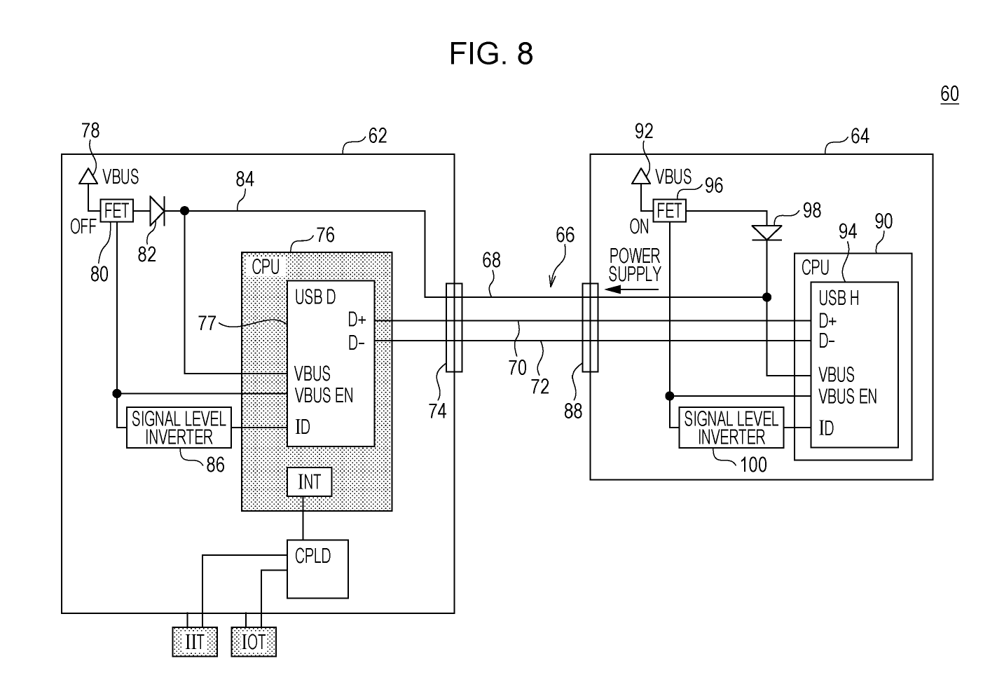

The operation of the information processing system 60 when the image forming apparatus 62 is in the power-saving mode (power-saving state) will be described below with reference to FIG. 8. FIG. 8 illustrates the configuration of the information processing system 60 when the image forming apparatus 62 is in the power-saving mode.

It is assumed that the image forming apparatus 62 is in the non-power-saving mode. In this case, if the image forming apparatus 62 does not perform any processing, such as image forming processing, for a predetermined period or if an instruction to shift to the power-saving mode is provided from a user, the USB controller 77 causes the image forming apparatus 62 to enter the power-saving mode (power-saving state), as in the first exemplary embodiment. An instruction to shift to the power-saving mode may be provided via the user interface of the image forming apparatus 62 or the user interface of the terminal apparatus 64. For example, if the user provides an instruction to shift to the power-saving mode by using the terminal apparatus 64 when the image forming apparatus 62 is in the non-power-saving mode, information indicating this instruction is sent from the terminal apparatus 64 to the image forming apparatus 62 via the USB cable 66. The USB controller 77 receives this information and causes the image forming apparatus 62 to shift to the power-saving mode.

When the image forming apparatus 62 is in the power-saving mode (power-saving state), the USB controller 77 outputs a VBUS control signal for turning OFF the FET 80 (VBUS control signal indicating a signal level “L”, for example), thereby turning OFF the FET 80. This causes the power supply unit 78 to stop supplying power to the elements (including the controller 76) of the image forming apparatus 62. The image forming apparatus 62 then functions as a non-host device (USB device). The power supply unit 78 also stops supplying power to the terminal apparatus 64.

The VBUS control signal is inverted by the signal level inverter 86 and is input into the USB controller 77 via the terminal ID as an ID signal. The level of the inverted VBUS control signal (ID signal) is “H”, that is, the VBUS control signal indicates that the image forming apparatus 62 will act as a non-host device (USB device). Upon receiving this ID signal, the USB controller 77 identifies based on the ID signal that the image forming apparatus 62 is a non-host device (USB device).

When power supply from the image forming apparatus 62 to the terminal apparatus 64 has stopped, the USB controller 94 of the terminal apparatus 64 outputs a VBUS control signal for turning ON the FET 96 (VBUS control signal indicating a signal level “H”, for example), thereby turning ON the FET 96. This causes the power supply unit 92 to supply power to the elements (including the controller 90) of the terminal apparatus 64. The USB controller 94 is then driven to send and receive data to and from the image forming apparatus 62. Power from the power supply unit 92 is also supplied to the image forming apparatus 62 via the FET 96, the diode 98, the power supply line, the connector 88, and the VBUS line 68 of the USB cable 66. The terminal apparatus 64 acts as a host device (USB host) in this manner.

The VBUS control signal is inverted by the signal level inverter 100 and is input into the USB controller 94 via the terminal ID as an ID signal. The level of the inverted VBUS control signal (ID signal) is “L”, that is, the VBUS control signal indicates that the terminal apparatus 64 will act as a host device (USB host). Upon receiving this ID signal, the USB controller 94 identifies based on the ID signal that the terminal apparatus 64 is a host device (USB host) and controls a data sending and receiving operation for a host device.

Power is supplied from the terminal apparatus 64 to the image forming apparatus 62 via the VBUS line 68 of the USB cable 66, and is then supplied to the USB controller 77 via the power supply line 84 and the terminal VBUS. The USB controller 77 is then driven to send and receive data to and from the terminal apparatus 64. The image forming apparatus 62 acts as a non-host device (USB device) in this manner.

When the image forming apparatus 62 is in the power-saving mode (power-saving state), if the user operates the terminal apparatus 64 to send an instruction to shift back to the non-power-saving state, information indicating a request to shift back to the non-power-saving state is sent from the terminal apparatus 64 to the image forming apparatus 62 via the USB cable 66. Upon receiving this information, the USB controller 77 outputs a VBUS control signal for turning ON the FET 80 (VBUS control signal indicating a signal level “H”, for example), thereby turning ON the FET 80. This causes the power supply unit 78 to supply power to the elements of the image forming apparatus 62, so that the image forming apparatus 62 can shift from the power-saving mode (power-saving state) to the non-power-saving mode (standby state). This enables the image forming apparatus 62 to act as a host device (USB host). The USB controller 77 also identifies based on the ID signal that the image forming apparatus 62 is a host device. Power is also supplied from the image forming apparatus 62 to the terminal apparatus 64. The USB controller 94 of the terminal apparatus 64 is then driven and turns OFF the FET 96 so as to cause the power supply unit 92 to stop supplying power to the elements of the terminal apparatus 64. This enables the terminal apparatus 64 to act as a non-host device (USB device). In this manner, when information indicating a request to shift back to the non-power-saving state from the power-saving state is sent from the terminal apparatus 64 to the image forming apparatus 62, the image forming apparatus 62 shifts back to the non-power-saving state and acts as a host device, and the terminal apparatus 64 acts as a non-host device.

The state transition table indicating the states of the image forming apparatus 62 and the terminal apparatus 64 is the same as that of the first exemplary embodiment shown in FIG. 4, and an explanation thereof will thus be omitted.

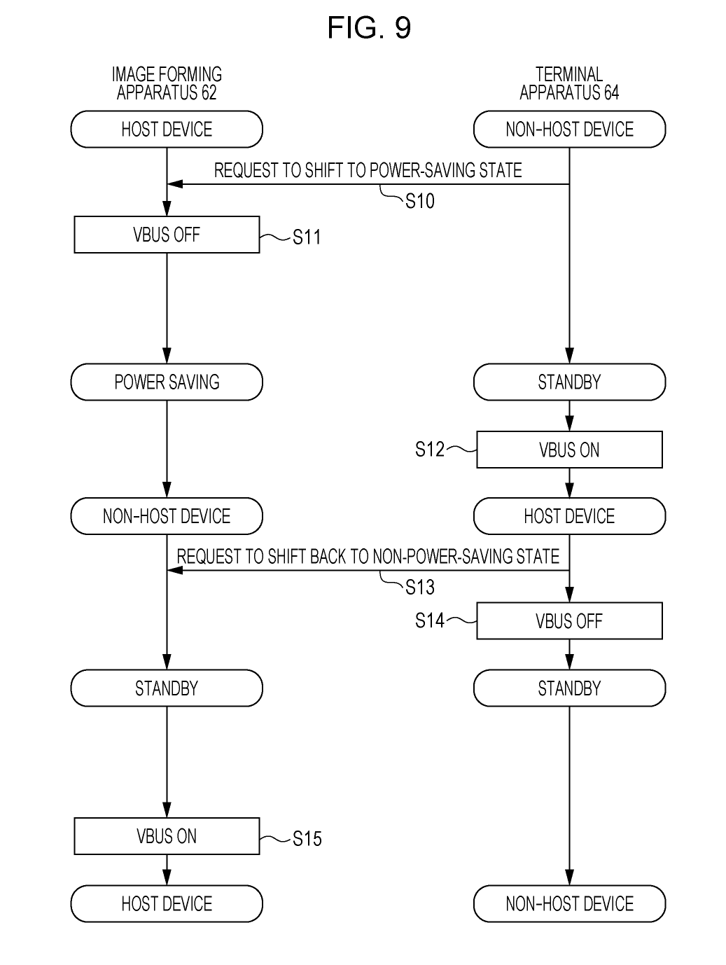

The operation of the information processing system 60 will be described below with reference to the sequence diagram of FIG. 9.

It is assumed that the image forming apparatus 62 now acts as a host device (USB host) and the terminal apparatus 14 now acts as a non-host device (USB device). In this state, a user operates the terminal apparatus 64 to provide an instruction to cause the image forming apparatus 62 to shift to the power-saving state. Then, information indicating a request to shift to the power-saving state is sent from the terminal apparatus 64 to the image forming apparatus 62 via the USB cable 66 (S10).

Upon receiving this information from the terminal apparatus 64, the USB controller 77 of the image forming apparatus 62 causes the power supply unit 78 to stop supplying power (VBUS OFF) (S11). The USB controller 77 also identifies based on the ID signal that the image forming apparatus 62 will act as a non-host device (USB device). Then, the image forming apparatus 62 can shift to the power-saving mode (power-saving state) and act as a non-host device (USB device).

The USB controller 94 of the terminal apparatus 64 causes the power supply unit 92 to supply power to the elements of the terminal apparatus 64 (VBUS ON) (S12). Power is then supplied from the terminal apparatus 64 to the image forming apparatus 62 via the USB cable 66 so as to drive the USB controller 77 of the image forming apparatus 62. The USB controller 94 of the terminal apparatus 64 identifies based on the ID signal that the terminal apparatus 64 will act as a host device (USB host). The terminal apparatus 64 acts as a host device (USB host) in this manner.

Thereafter, if the user operates the terminal apparatus 64 to provide an instruction to cause the image forming apparatus 62 to shift back to the non-power-saving state from the power-saving state, information indicating a request to shift back to the non-power-saving state is sent from the terminal apparatus 64 to the image forming apparatus 62 via the USB cable 66 (S13).

The USB controller 94 of the terminal apparatus 64 then causes the power supply unit 92 to stop supplying power (VBUS OFF) (S14). The terminal apparatus 64 then acts as a non-host device (USB device).

Upon receiving information indicating a request to shift back to the non-power-saving state from the terminal apparatus 64, the USB controller 77 of the image forming apparatus 62 causes the power supply unit 78 to supply power to the elements of the image forming apparatus 62 (VBUS ON) (S15). The USB controller 77 also identifies based on the ID signal that the image forming apparatus 62 will act as a host device (USB host). The image forming apparatus 62 acts as a host device (USB host) in this manner. Power from the power supply unit 78 is also supplied from the image forming apparatus 62 to the terminal apparatus 64.

In the second exemplary embodiment, in accordance with the state of the image forming apparatus 62 (the power-saving state or the standby state), the states of the image forming apparatus 62 and the terminal apparatus 64 can be dynamically switched between a host device and a non-host device based on the ID signal.

When the image forming apparatus 62 is in the power-saving mode, the power supply unit 78 stops supplying power to the elements of the image forming apparatus 62, and the USB controller 77 is driven by power supplied from the terminal apparatus 64. It is thus possible to reduce power consumed in the image forming apparatus 62.

After the image forming apparatus 62 shifts to the power-saving mode, the terminal apparatus 64 acts as a host device (USB host). The terminal apparatus 64 is thus able to provide a request to shift back to the non-power-saving state from the power-saving state to the image forming apparatus 62. This enables the image forming apparatus 62 to shift back to the non-power-saving mode (standby state).

When the image forming apparatus 62 is in the power-saving mode, if the terminal apparatus 64 receives a job, such as a print job, it may send information indicating a request to shift back to the non-power-saving state from the power-saving state to the image forming apparatus 62, as in the first exemplary embodiment. If the charging level in the power supply source (power supply unit 92) of the terminal apparatus 64 becomes lower than a predetermined threshold, the terminal apparatus 64 may send information indicating a request to shift back to the non-power-saving state from the power-saving state to the image forming apparatus 62. In this case, the terminal apparatus 64 may display alarm information on the user interface of the terminal apparatus 64, output alarm sound, or cause a light source to blink.

Each of the image forming apparatus 62 and the terminal apparatus 64 may be implemented as a result of software and hardware operating together. More specifically, each of the image forming apparatus 62 and the terminal apparatus 64 includes one or plural processors, such as CPUs, which are not shown. As a result of this processor or these processors reading and executing a program stored in a storage device, which is not shown, the functions of the image forming apparatus 62 and the terminal apparatus 64 are achieved. This program is stored in a storage device by using a recording medium, such as a CD or a DVD, or via a communication path, such as a network. In the example shown in FIG. 6, each of the controller 76 of the image forming apparatus 62 and the controller 90 of the terminal apparatus 64 is constituted by one or plural CPUs. Alternatively, the functions of the image forming apparatus 62 and the terminal apparatus 64 may be achieved by using hardware resources, such as a processor, an electronic circuit, and an ASIC. In this case, a device, such as a memory, may be used. Alternatively, the functions of the image forming apparatus 62 and the terminal apparatus 64 may be achieved by using a DSP or a FPGA.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a switching unit that switches the information processing apparatus to a host device or a non-host device in accordance with a state of the information processing apparatus, the information processing apparatus performing a data sending and receiving operation with an external apparatus via a data line which is compliant with a predetermined standard; and
a controller that controls a data sending and receiving operation performed with the external apparatus, the controller controlling a data sending and receiving operation for a host device when the information processing apparatus is switched to the host device, the controller controlling a data sending and receiving operation for a non-host device when the information processing apparatus is switched to the non-host device.

2. The information processing apparatus according to claim 1, wherein:
the controller includes
a host controller that controls a data sending and receiving operation for a host device, and
a non-host controller that controls a data sending and receiving operation for a non-host device; and
the switching unit switches the information processing apparatus to the host device by connecting the data line to the host controller, and switches the information processing apparatus to the non-host device by connecting the data line to the non-host controller.

3. The information processing apparatus according to claim 2, further comprising:
a power supply unit that supplies power, wherein
when the information processing apparatus is switched to the host device, the host controller is driven by receiving power from the power supply unit so as to control a data sending and receiving operation performed with the external apparatus and to cause the power supply unit to supply power to the external apparatus, and
when the information processing apparatus is switched to the non-host device, the host controller causes the power supply unit to stop supplying power to the host controller, the non-host controller, and the external apparatus, and the non-host controller is driven by receiving power from the external apparatus so as to control a data sending and receiving operation performed with the external apparatus.

4. The information processing apparatus according to claim 3, wherein, if the state of the information processing apparatus is a power-saving state, the switching unit connects the data line to the non-host controller, and if the state of the information processing apparatus is not the power-saving state, the switching unit connects the data line to the host controller.

5. The information processing apparatus according to claim 4, wherein, if the state of the information processing apparatus is the power-saving state, the switching unit connects the data line to the host controller upon receiving information including processing control information from the external apparatus, the information being sent as a result of the external apparatus receiving the processing control information.

6. The information processing apparatus according to claim 1, wherein the switching unit switches the information processing apparatus to the host device or the non-host device in accordance with identification information indicating whether the information processing apparatus is the host device or the non-host device.

7. The information processing apparatus according to claim 6, further comprising:
a power supply unit that supplies power, wherein
if the identification information indicates that the information processing apparatus is the host device, the controller is driven by receiving power from the power supply unit so as to control a data sending and receiving operation performed with the external apparatus and to cause the power supply unit to supply power to the external apparatus, and
if the identification information indicates that the information processing apparatus is the non-host device, the controller causes the power supply unit to stop supplying power to the controller and the external apparatus and is driven by receiving power from the external apparatus so as to control a data sending and receiving operation with the external apparatus.

8. The information processing apparatus according to claim 7, wherein, if the state of the information processing apparatus is the power-saving state, the identification information indicates that the information processing apparatus is the non-host device, and if the state of the information processing apparatus is not the power-saving state, the identification information indicates that the information processing apparatus is the host device.

9. The information processing apparatus according to claim 8, wherein, if the state of the information processing apparatus is the power-saving state, upon receiving information including processing control information from the external apparatus, the information being sent as a result of the external apparatus receiving the processing control information, the controller is driven by receiving power from the power supply unit so as to control a data sending and receiving operation performed with the external apparatus and to cause the power supply unit to supply power to the external apparatus.

10. A non-transitory computer readable medium storing a program causing a computer to execute a process, the process comprising:
switching an apparatus to a host device or a non-host device in accordance with a state of the apparatus, the apparatus performing a data sending and receiving operation with an external apparatus via a data line which is compliant with a predetermined standard; and
controlling a data sending and receiving operation for a host device when the apparatus is switched to the host device and controlling a data sending and receiving operation for a non-host device when the apparatus is switched to the non-host device.

11. An information processing system comprising:
a first device; and
a second device that is connected to the first device via a data line and a power supply line, the data line being compliant with a predetermined standard,
the first device including
a switching unit that switches the first device to a host device or a non-host device in accordance with a state of the first device, and
a first controller that controls a data sending and receiving operation performed with the second device via the data line, the first controller controlling a data sending and receiving operation for a host device when the first device is switched to the host device, the first controller controlling a data sending and receiving operation for a non-host device when the first device is switched to the non-host device,
the second device including
a second controller that controls a data sending and receiving operation for a non-host device when the first device is switched to the host device and that controls a data sending and receiving operation for a host device when the first device is switched to the non-host device.

12. The information processing system according to claim 11, wherein:
the first device further includes a first power supply unit that supplies power;
the second device further includes a second power supply unit that supplies power;
when the first device is switched to the host device, the first controller is driven by receiving power from the first power supply unit so as to control a data sending and receiving operation performed with the second device and to cause the first power supply unit to supply power to the second device, and the second device is driven by receiving power from the first power supply unit so as to control a data sending and receiving operation performed with the first device and to cause the second power supply unit to stop supplying power to the first device and the second device; and
when the first device is switched to the non-host device, the first controller causes the first power supply unit to stop supplying power to the first controller and the second device, and the second controller is driven by receiving power from the second power supply unit so as to control a data sending and receiving operation performed with the first device and to control the second power supply unit to supply power to the first device, and the first controller is driven by receiving power from the second power supply unit so as to control a data sending and receiving operation performed with the second device.
